(19) United States
(12) Patent Application Publication
(10) Pub. No.: US 2016/0234551 A1
(43) Pub. Date: Aug. 11, 2016

(54) VIDEO REACTION PROCESSING

(71) Applicant: DUMBSTRUCK, INC., Albany, NY (US)

(72) Inventors: Peter Vincent Allegretti, Albany, NY (US); Michael Stephen Tanski, Albany, NY (US)

(21) Appl. No.: 15/132,687

(22) Filed: Apr. 19, 2016

Related U.S. Application Data
(63) Continuation-in-part of application No. 14/558,246, filed on Dec. 2, 2014.
(60) Provisional application No. 61/910,460, filed on Dec. 2, 2013.
(60) Provisional application No. 61/912,887, filed on Dec. 6, 2013.
(60) Provisional application No. 61/948,320, filed on Mar. 5, 2014.

(51) Int. Cl. H04N 21/442; H04N 21/25; H04N 21/258; H04N 21/234

(52) U.S. Cl. CPC H04N 21/44218; H04N 21/23418; H04N 21/251; H04N 21/25883

(57) ABSTRACT

A disclosed system provides a software developer kit (SDK) having programming code that is installable on a content delivery platform, and when installed and executed provides: a reaction interface that is displayed within the content delivery platform and allows client devices to capture and upload video reactions in response to content items served by the content delivery platform, wherein each video reaction is externally stored in a remote server and is viewable in the reaction interface, and wherein the reaction interface includes a sharing facility that allows video reactions to be shared over a network; an aggregation interface that visually aggregates, in the reaction interface, sets of video reactions with associated content items served by the content delivery platform; and an analytics interface that displays reaction analytics for content items, wherein the reaction analytics include emotional analytics, demographic analytics, and engagement analytics.

### PRIORITY CLAIM

This Continuation-in-part application claims priority to co-pending U.S. patent application entitle VIDEO REACTION PROCESSING, Ser. No. 14/558,246 filed on Dec. 2, 2014, which claims priority to the following co-pending U.S. Provisional Applications: (1) SYSTEM AND METHOD FOR AUTOMATED CAPTURE OF AND REPLIES TO VIDEO REACTIONS, 61/910,460, filed 2 Dec. 2013; (2) SYSTEM AND METHOD FOR VIDEO PROCESSING ON A MOBILE DEVICE, 61/948,320, filed 5 Mar. 2014; and (3) SYSTEM AND METHOD FOR CAPTURING AND ANALYZING VIDEO REACTIONS TO ADVERTISEMENTS, Ser. No. 61/912,887, filed 6 Dec. 2013.

### TECHNICAL FIELD

The present invention generally relates to systems and methods for capturing and processing reactions to displayed content.

### BACKGROUND

The Web and social media universe has become a primary driver of content and media. One of the challenges with these platforms involves the ability to successfully assess a user's reaction to content and aggregate reactions in some meaningful way. There exist only very limited mechanisms for determining whether content is being received favorably by the viewer, negatively by the viewer, passively by the viewer, etc. Without such feedback, content providers cannot readily improve and fine tune messaging being pushed into the Web and social media universe.

Additionally, there are only very limited mechanisms for brands, media companies, celebrities, etc., to engage with their fans using video. Accordingly, fan engagement is typically limited to one-way messaging such as with Twitter or Facebook.

### SUMMARY

Aspects of the present invention drive increased viewing of an organization's content, increased audience engagement, and creates a general feeling among an audience that they are “closer” to an organization, entity or celebrity. As described, short snippets of two-way, temporally synced video are collected, analyzed and processed.

A first aspect provides a system for processing reactions, comprising: a content loader for inputting content items from content provider nodes; a content publication system for publishing a content item to at least one channel node, wherein the channel node provides a platform for displaying the content item and simultaneously capturing reaction content; an aggregation system for aggregating content items and associated reaction content in a database; an analysis system for analyzing reaction content to create reaction analysis data; and a reporting system for outputting reaction content and reaction analysis data.

A second aspect provides a reaction capture system, comprising: an interface displayable on a computing device, wherein the interface includes a system for receiving a notification of a video content item available for display; a display system for causing the video content item to be displayed; a capture system for causing video reaction content to be captured with a recording device simultaneously with the video content item being displayed; and an on-the-fly video processing system that processes the video reaction content as it is being captured, wherein the processing formats the video reaction content into a non-native format having parameters different than the default parameters of the recording device.

A third aspect provides a computerized method for processing reactions, comprising: inputting content items from content provider nodes into a computerized storage; publishing a content item to at least one channel node, wherein the channel node provides a platform for displaying the content item and simultaneously capturing reaction content; aggregating content items and associated reaction content in a database; analyzing reaction content to create reaction analysis data; and outputting reaction content and reaction analysis data.

A fourth aspect provides a software developer kit (SDK) comprising programming code that is installable on a content delivery platform, and when installed and executed, comprises: a reaction interface that is displayed with the content delivery platform and that captures and uploads video reactions from client devices in response to content items served by the content delivery platform, wherein each video reaction is externally stored in a remote server and is viewable in the reaction interface, and wherein the reaction interface includes a sharing facility that allows video reactions to be shared over a network; an aggregation interface that visually aggregates, in the reaction interface, sets of video reactions with associated content items served by the content delivery platform; and an analytics interface that displays reaction analytics for content items, wherein the reaction analytics include emotional analytics, demographic analytics, and engagement analytics.

In a fifth aspect, the invention provides a content delivery platform, comprising: a reaction interface that captures and uploads video reactions from client devices in response to content items served by the content delivery platform, wherein uploaded video reactions are externally stored in a remote server and are viewable in the reaction interface, and wherein the reaction interface includes a sharing facility that allows video reactions to be shared over a network; an aggregation interface that visually aggregates, in the reaction interface, sets of video reactions with associated content items served by the content delivery platform; and an analytics interface that displays reaction analytics for content items, wherein the reaction analytics include emotional analytics, demographic analytics, and engagement analytics.

In a sixth aspect, the invention provides a computer program product stored a computer readable storage medium, which when executed by a computing system having a content delivery platform, comprises: program code that captures and uploads video reactions from client devices in response to content items served by the content delivery platform, wherein uploaded video reactions are externally stored in a remote server; program code that visually aggregates sets of video reactions with associated content items served by the content delivery platform; program code for displaying video reactions; program code that shares video reactions over a network; and program code that displays reaction analytics for content items, wherein the reaction analytics include emotional analytics, demographic analytics, and engagement analytics.

### BRIEF DESCRIPTION OF THE DRAWINGS

These and other features of this invention will be more readily understood from the following detailed description of the various aspects of the invention taken in conjunction with the accompanying drawings in which:

FIG. 1 depicts a client and server, in accordance with an embodiment of the present invention;

FIG. 2 depicts a dashboard interface, in accordance with an embodiment of the present invention;

FIGS. 3-5 depict dashboard analytics, in accordance with an embodiment of the present invention;

FIG. 6 depicts a schematic overview of a computing device, in accordance with an embodiment of the present invention;

FIG. 7 depicts a network schematic of a system, in accordance with an embodiment of the present invention; and

FIGS. 8-10 depict process flows according to embodiments of the invention.

FIG. 11 depicts a reaction processing system according to embodiments of the invention.

FIG. 12 depicts a split screen interface used to view content items and reactions.

FIG. 13 depicts a content delivery platform having an embedded video reaction system according to embodiments.

FIG. 14 depicts illustrative reaction interfaces according to embodiments.

FIG. 15 depicts further illustrative reaction interfaces according to embodiments.

FIG. 16 depicts a data analysis and reporting system according to embodiments.

The drawings are not necessarily to scale. The drawings are merely schematic representations, not intended to portray specific parameters of the invention. The drawings are intended to depict only typical embodiments of the invention, and therefore should not be considered as limiting the scope of the invention. In the drawings, like numbering represents like elements.

### DETAILED DESCRIPTION

The disclosed embodiments generally relate to systems and methods for the capture, analysis, and aggregation of instant reactions of users viewing content, including those engaged in social media activities, audience engagement and marketing analysis. Embodiments are disclosed that allow content messages to be viewed in various platforms while a viewer's reaction to a message is simultaneously recorded.

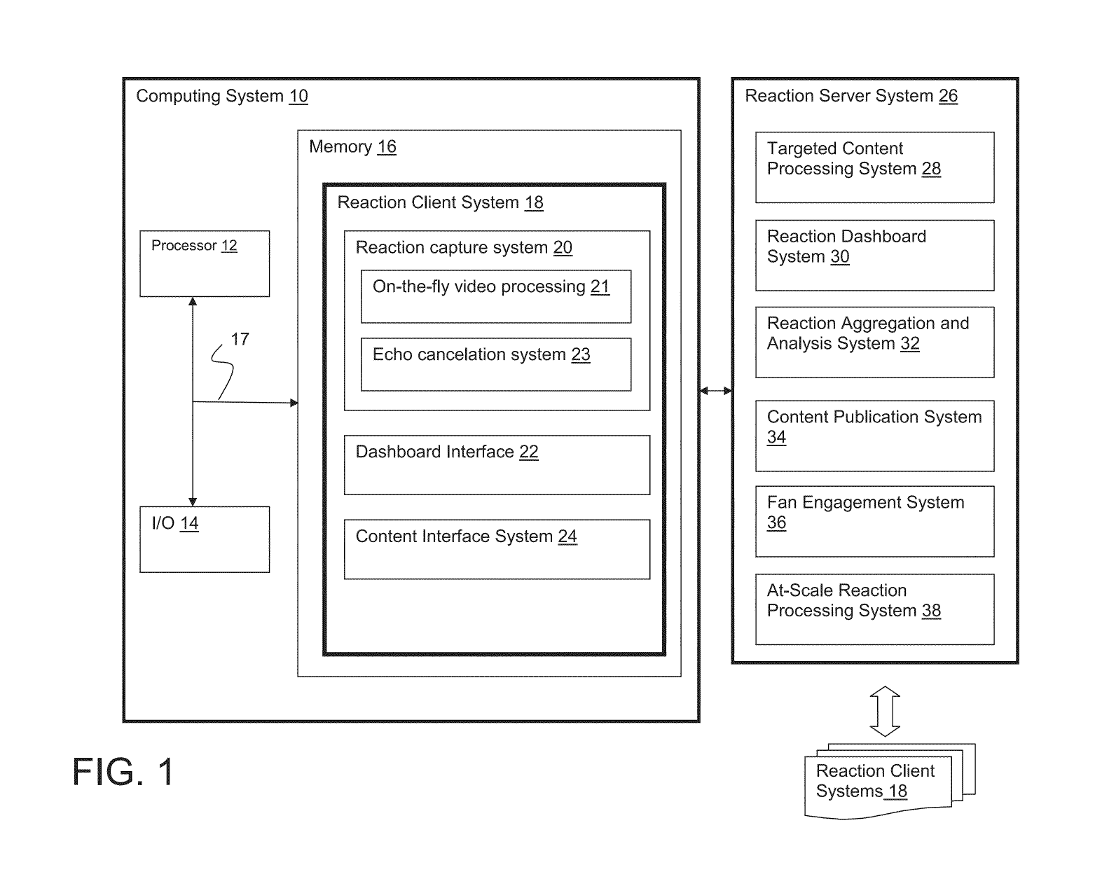

FIG. 1 depicts a computer infrastructure for implementing some of the features and systems described herein. The infrastructure generally includes a reaction server system 26 and a set of reaction client systems 18 (one shown in detail). Reaction client system 18 may be stored and executed within any type of computing system 10, such as a smartphone, personal computer, specialized hardware system, etc. Depending on the implementation, reaction client system 18 generally includes: a reaction capture system 20 for capturing a video and/or audio reaction (or reaction content) in response to a user viewing content (i.e., message content); a dashboard interface 22 that interfaces with a reaction dashboard system 30 on reaction server system 26; and a content interface system 24 that allows a user to view content and capture reaction content, e.g., with a video recording device integrated in the computing system 10.

Reaction capture system 20 also may include: a video post processing system 21 that converts captured video from a native format to a non-native format on-the-fly; and a echo cancellation system 23 that can cancel out an audio echo or feedback created when the reaction capture system 20 is capturing a user's auditory response at the same time audio content is being broadcast for the user.

Reaction server system 26 includes various systems for managing display and reaction content and associated data, including, e.g.: targeted content processing system 28 that manages content and associated reactions targeted to specific viewers; a reaction dashboard system 30 for allowing users to set up or view reaction-based data; a reaction aggregation and analysis system 32 that aggregates and analyzes reaction content, and allows for the analysis of a large of amount of reaction content; a content publication system 34 that manages, tracks and/or stores message content and associated reaction content; a fan engagement system 36 that allows fans of celebrities to post content that a celebrity can react to, e.g., in a fan engagement booth described herein, or allows organizers to post content for fans to react to; and an at-scale reaction processing system 38 for managing the collection of multiple reactions to a single piece of message content.

It is understood that some or all of these features may be implemented on one or both the reaction client 18 and reaction server system 26. Furthermore, additional features may be incorporated, including those described elsewhere herein. The following description provides additional detail regarding these features.

### Reaction Capture System

In a first general embodiment, a reaction server system 26 is provided to receive a message from a first reaction client system 18 (i.e., user) who generated a message via a computing device 10. The message comprises both the actual message content, as well as a list of recipients for the message to be delivered to. The messages are delivered to other reaction client systems 18 (i.e., recipients) who are identified/registered by a unique identifier by the system (e.g. email address, phone number, username).

Once a message is received by the reaction server system 26, the system 26 processes the message into its applicable parts. The message content of the message is formatted for delivery to the recipients and the recipients may be identified and confirmed prior to transmission of the message to each recipient. In certain embodiments, recipients who have not previously accessed or been identified by the system may be communicated with by an external identifier (e.g., phone number, email address), by which the system can contact the intended recipient and notify the intended recipient that a message is waiting for them.

Once the reaction server system 26 has processed the message, the system 26 will then transmit the message to the one or more reaction client systems 18 (i.e., the intended recipients). Upon receipt on the intended recipient's associated computing device 10, the computing system 10 of the recipient may notify the intended recipient of receipt of the message by way of a notification (e.g., beep, vibration, force feedback, tone, sound, music, etc).

The message, as received by each recipient, may be initially obscured from initial review until interaction by the recipient. For instance, the initial message received and viewed by the recipient may be blurred, frosted, pixelated or any combination thereof. One of ordinary skill in the art would appreciate that there are numerous methods for obscuring message content, and embodiments of the present invention are contemplated for use with any method for obscuring message content.

Reaction capture system 20 running on the computing device 10 may be configured to detect the availability of an appropriate reaction recording device and/or the availability of the appropriate recipient. This may include both confirming status and ability to use the reaction recording device (e.g., front facing camera on a mobile computing device). Further, this may include confirming the viewer is the intended recipient of the message. This may be accomplished by automated identification of the recipient by the reaction recording device in conjunction with images of the intended recipient stored on the system's components or provided to the system from the user. One of ordinary skill in the art would appreciate that there are numerous methods for automated identification of the recipient, and embodiments of the present invention are contemplated for use with any method for automated identification.

Once the reaction capture system 20 has confirmed that the recipient is ready to view the content of the message, and, optionally, that the recording device is ready and the appropriate recipient is verified, the message content is provided to the recipient concurrent with the recording of the recipient's reaction to the message content. In illustrative embodiments, the recording of the reaction may include a time period before and after display of the message content, to ensure that the entire reaction is recorded (including how the recipient looked prior to receiving the content, to the continued reaction of the user after the content has been displayed).

The reaction capture system 20 may be configured to use one or more markers to determine the beginning and end points of the reaction recording. For instance, the beginning may be any point prior to or at the moment of initial display of the message content. The end point may be, for instance, a specified amount of time, a duration based on the length of the content (e.g., content video length, estimated reading time for content, content audio length), determined by a demeanor or reaction of the recipient (e.g., returning to normal after the reaction), determined by an interaction with the mobile computing device by the recipient (e.g., pressing of a button or touch screen), or any combination thereof. One of ordinary skill in the art would appreciate that there are numerous types of end points and begin points that could be utilized with embodiments of the present invention, and embodiments of the present invention are contemplated for use with any begin and end point.

Once the reaction has been captured, it may be sent to the reaction server system 26 for processing to a non-native format. Non-native processing of the reaction may include, but is not limited to, trimming or otherwise editing the length of the reaction based on facial, audio or other system analysis that allows for the determination of logical start and end points to the reaction. Other processing may include compression of file size, change in quality, bit rate or other metric, change in file type, change in encoding standard, or any combination thereof. In an alternative embodiment, an on-the-fly processing system 21 may be built into the reaction capture system 20 to perform the necessary processing on-the-fly. This process is described in further detail herein. One of ordinary skill in the art would appreciate that there are numerous types of processing that could occur, and embodiments of the present invention are contemplated for use with any type of processing.

Once the reaction is processed, the reaction content may be presented to the user for review. Depending on where the processing takes place, the processed reaction content may be saved or sent back to the computing system 10 of the user. In other embodiments, the reaction server system 26 may store the content remotely and provide the user a link (i.e., Uniform Resource Locator) or other means to access the content.

The viewing user may be given the option to OK the recorded reaction content, or have the reaction content re-recorded. In other cases, the viewing user may be given the opportunity to provide multiple reactions to the same content message. In other cases, the sending user may request that the viewing user “re-view” the message content to have the reaction recaptured.

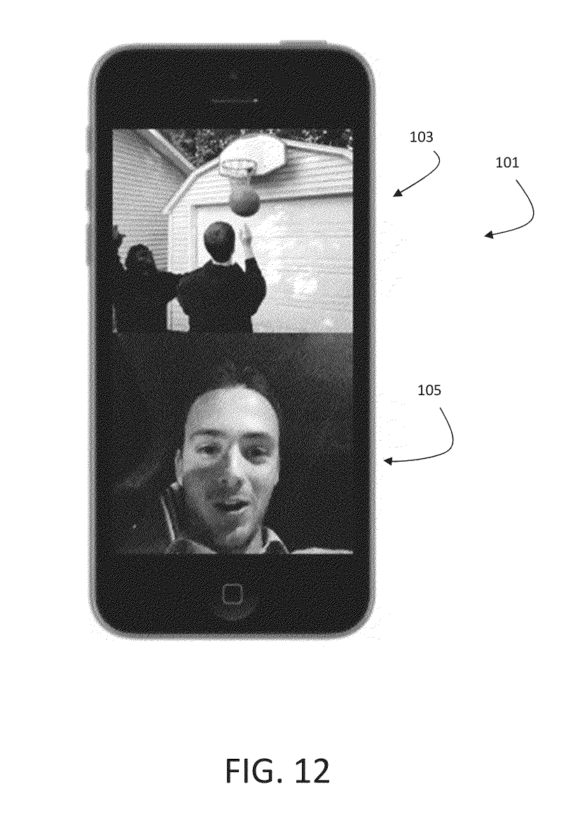

FIG. 12 depicts an illustrative split-screen interface 101 for displaying simultaneous video that includes a top window for showing the original video 103 and a bottom window for showing a reaction video 105. When playing both videos are synched such that the reaction video shows the user's reaction in synchronization with the playing of the original content video. Although shown in a vertical mode, it is understood that the content windows could be presented side by side in a horizontal fashion or any other arrangement. Furthermore, the original content video and reaction video could be overlaid onto each other, or morphed together, e.g., using 3D imaging or any other means.

The reaction content may be configured to expire after the occurrence of some event. For instance, the reaction content may be deleted by the reaction server system 26 after a specified period of time (e.g., 24 hours). In other examples, the reaction content may be deleted by one or more of, request by the user, request by the recipient, number of total views or any combination thereof. In other cases, the reaction content is not deleted at all. One of ordinary skill in the art would appreciate that there are numerous events that could be utilized to expire the reaction content, and embodiments of the present invention are contemplated for use with any such event. In certain embodiments, the system may be configured to allow for the sharing and transmission of the reaction content to third party services, such as social media sites and amongst contacts of the recipient or the user.

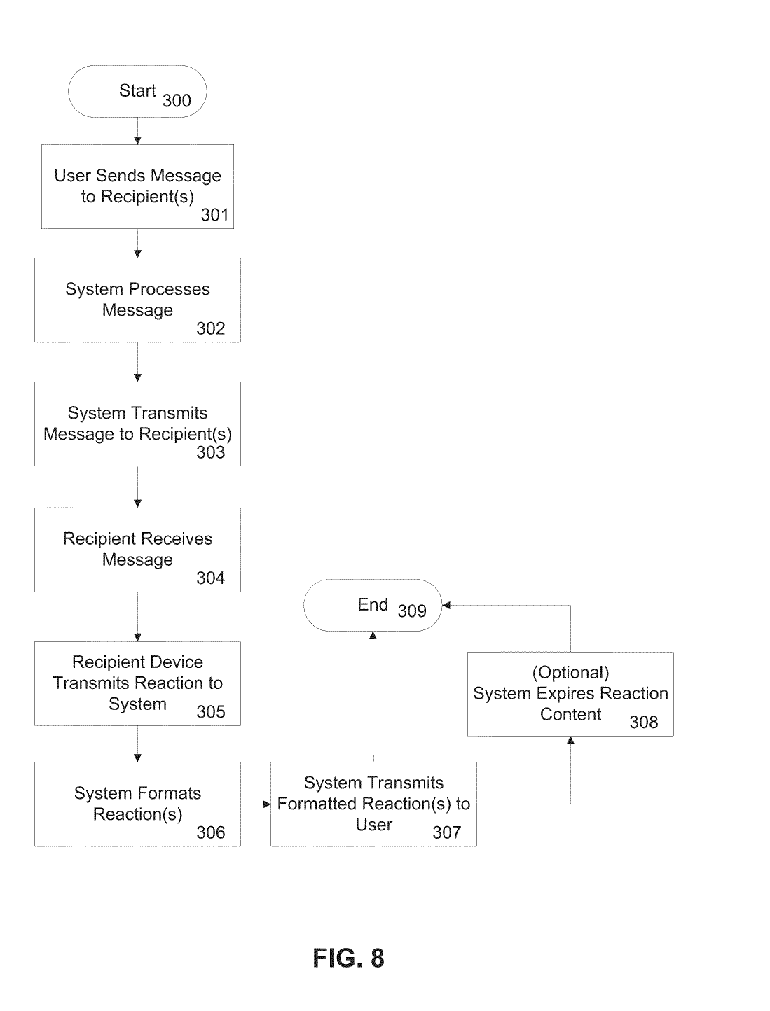

Turning now to FIG. 8, an illustrative method is shown, in accordance with an embodiment of the present invention. The process starts at step 300 with a user wishing to send a message to one or more recipients in order to get their reaction to the content of the message. At step 301, the user sends the message to the reaction server system 26 for processing. At this point, generally the user has determined the content of the message and the intended recipients and sends this information, generally via a mobile computing device or other computing device, to the server system 26 for further processing and transmission of the content.

At step 302, the server system 26 processes the message received from the user. The processing of the message generally includes, but is not limited to, the identification of message content and any required processing thereof and the identification of one or more recipients intended to receive the message content. Once message processing is complete, the server system 26 transmits the message content to the one or more recipients identified by the user (Step 303).

At step 304, the recipient(s) receive the message content and are notified of the receipt of the message. At this point the message content is obscured and not visible or viewable by the recipient. Once the recipient engages their mobile computing device or other computing system 10 and confirms that they wish to view the content, the process may proceed. Prior to providing the content, the server system 26 and/or reaction capture system 20 may optionally require that the recipient be confirmed (see above regarding recipient identification) and that one or more reaction recording means be available (see above regarding availability of forward facing camera or other video/audio capture device).

At this point, the message content is displayed to the recipient(s) and the reaction is recorded. Once recorded, the reaction is transmitted to the system (step 305). Once received by the system, the system will process and format the reaction as described herein. In certain embodiments, where there are multiple recipients, the system may wait until a certain number of reactions are received prior to processing, such that the reactions are processed into a single reaction file or a plurality of processed files to be transmitted to the user.

At step 307, the system transmits the formatted reaction(s) to the user for review. At this point the process terminates at step 309. In certain optional embodiments, the system may be configured to expire the content at some point (step 308) prior to termination at step 309.

### On-the-Fly Video Processing

As noted, an on-the-fly video processing system 21 may be provided to instantly process video into a non-native format, e.g., as it is being recorded at the reaction client system 18. In this approach, the processing of the video occurs nearly simultaneously with the recording of the video. As each frame of the video is recorded in a native format specific to the device (e.g., Android, iOS, etc.) capturing the video/audio reaction content, it is also instantly processed by the on-the-fly video processing system 21, frame-by-frame, and “on the fly” so as to produce a fully processed video at nearly the same moment that a recording is stopped. The processed video is a non-native format tailored for use for a specific application, such as the video reaction processes described herein. This is in contrast to existing systems and methods that convert video to non-native formats, e.g., where a mobile device records a video in a native, i.e., default resolution and orientation and then uploads that video to a server for further processing or processes the entire video content upon termination of recording operations.

In alternate embodiments, each frame or a block of two or more frames may be sent for remote processing at one or more remote video processing sites, such that the video is remotely processed while it is being recorded (e.g., recorded on a mobile device transmitting each frame or block of frames to a remote computing device for processing).

The on-the-fly video processing system 21 decreases the time needed to prepare a video for an application having non-native requirements. In one embodiment, the system 21 is configured to provide processing of a video on a mobile device that can record video. As each frame of the video is recorded, it is instantly processed by the system, essentially providing simultaneously video recording and processing. The decrease in processing time is achieved because the video is processed, frame-by-frame, as it is recorded. As a result of the “on the fly” video processing that occurs simultaneously with the recording of the video, the system is able to provide a fully processed video at the same time the recording is finished.

In one embodiment, the on-the-fly video processing system 21 is configured to process the video according to a set of parameters that are different from the native recording format parameters. The processing parameters may include, but are not limited to, cropping the physical frame size of the video, setting the bitrate and encoding parameters of the video and audio to control file size and quality, rotating the video for display on portrait devices, and writing additional overlays into the video such as watermarks or captions. One of ordinary skill in the art would appreciate that there are numerous processing parameters that could be applied to a recorded video, and embodiments of the present invention are contemplated for use with any such processing parameters.

According to an embodiment of the present invention, the processed video provided by the on-the-fly video processing system 21 has a smaller file size than the video recorded using the native parameters of the mobile device. A typical mobile device is equipped with an operating system (e.g. Android® or iOS®) that causes video to be recorded according to set of default or native processing parameters that optimize the video to fit the screen of that particular mobile device. The system 21 is able to process the video according to a different set of parameters that results in a fully processed video that is both significantly smaller in file size and in a more universal format than a video that is recorded and processed according to the default processing parameters set by the operating system of the mobile device.

Furthermore, because a video is processed locally on the user's mobile device, a video with a small file size can be uploaded and directed through a server for storage more quickly. Overall, these improvements lead to decreased network and server costs, as well as increased upload speeds because the recorded video has been optimally processed while the video was recorded and before it was sent.

According to an embodiment of the present invention, the on-the-fly video processing system 21 is an application for video processing on a mobile phone. The on-the-fly video processing system 21 may be an application that is integrated into existing applications of a mobile device. As an illustrative example, the system 21 may be incorporated into a video messaging application to improve the speed at which a video message is sent. For example, if a video is processed while it is being recorded, a first user can then send that message to a second user without the video needing to be post-processed at a remote server. In an alternate preferred embodiment, the system 21 may be a standalone application. One of ordinary skill in the art would appreciate that many existing applications incorporate video and therefore would benefit from a system that can simultaneously record and process a video, and embodiments of the present invention are contemplated for use with any such existing applications.

Accordingly, the on-the-fly video processing system 21 may be used to improve a video messaging application, such as reaction capture system 20. Existing video messaging applications are inefficient and consume more networking and computing resources than is necessary, thereby increasing the costs of operating the video messaging application. Traditional video messaging applications operate by 1) recording a video in default resolution and orientation on the mobile device of a first user, 2) uploading that video file to a server for processing, 3) processing the video file on a server according to a set of processing parameters, 4) uploading the processed video file to a storage location, and 5) sending a location (e.g. URL) of the finished processed video file to a second user, wherein the second user can access and view the video at the location provided. The system 21 of the current invention improves upon the existing methods by streamlining this process to be more efficient.

According to an embodiment of the present invention, the on-the-fly video processing system 21 is integrated into an application that utilizes video. In an embodiment, the system is integrated into a video messaging application of mobile device. As a first mobile device records a video, the system 21 simultaneously causes that video to be processed on a frame-by-frame basis. When the video is finished recording, the video will be fully processed, resulting in a video that is both the proper resolution and orientation, as well as being of a reduced file size. At this point, the video file can be immediately uploaded to a server 26, without the need for additional processing at the server. Once the video has been received by the server 26, it will be associated with a location identifier, such as a web address or URL that can be sent or otherwise provided to a user of a second mobile device. The location identifier will allow the user of the second mobile device to access and view the video on the second mobile device. Alternatively, the location identifier may be sent to an email account or the entire video may be automatically uploaded to a website or storage location. One of ordinary skill in the art would appreciate that there are numerous ways to transfer or transmit a processed video file on a first mobile device to another to second mobile device, server, or website, and embodiments of the present invention are contemplated for use with any such means of transfer or transmission.

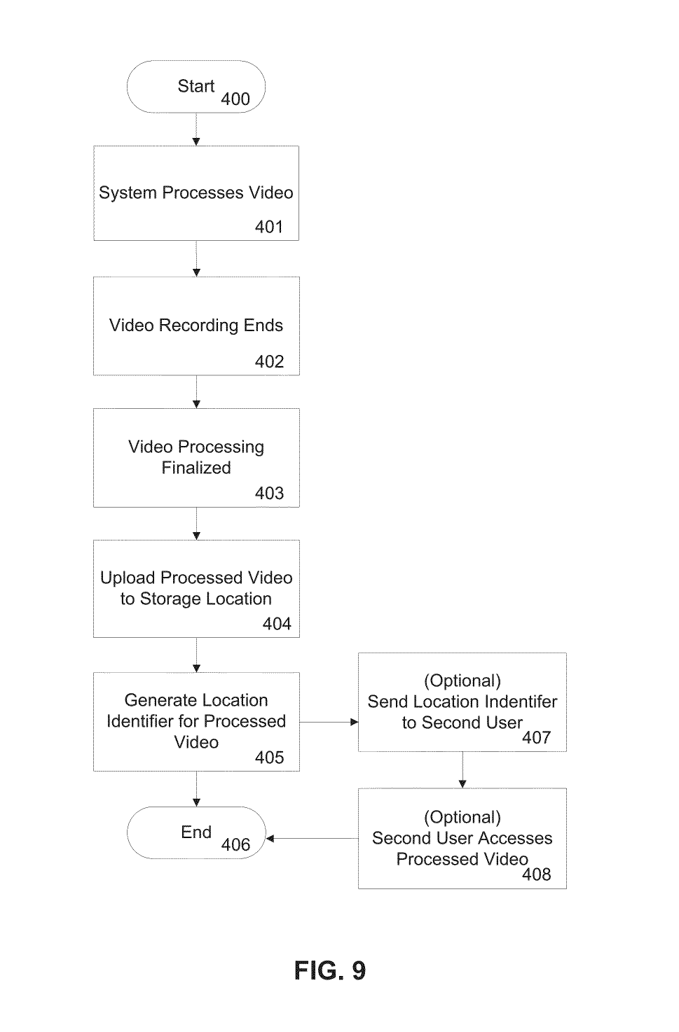

Turning now to FIG. 9, an illustrative method is shown, in accordance with an embodiment of the present invention. The process starts at step 400 when a user of a first mobile device begins to record a video. At step 401, the on-the-fly video processing system 21 immediately begins to post-process the video as it is recorded. As each frame of the video is recorded, it is instantly processed by the system into a non-native format so that a video can be both recorded and processed simultaneously.

At step 402, the user stops recording the video. The system 21 processes the final frame of the video thereafter. As a result, a complete finalized and fully processed video is prepared (step 403) almost immediately when the recording has stopped. This saves both time and network and computing resources because a user does not have to i) wait until a video recording is concluded to process the video or ii) upload the video to a remote server for processing.

At step 404, the video file is uploaded from the first mobile device to a storage location. The storage location may be a server 26 where the video file may be accessed by other users and computing devices.

At step 405, a location identifier is generated for the processed video. The location identifier may be a web address or URL at which the processed video may be accessed. At this point the process terminates at step 406.

In optional embodiments, the system 21 may cause the location identifier to be sent to a second user (step 407). The location identifier may be sent as message to a second user's mobile device. Alternatively, the location identifier may be sent in an email to a second user. As an additional alternative, the location identifier may be used to embed the processed video on a website. At step 408, the user accesses the video through use of the location identifier.

### Echo Cancellation

As noted, echo cancellation system 23 addresses issues relating to reducing or eliminating echo caused when, e.g., the reaction audio stream recording (of the reaction content) also includes the audio portion of the original content video. There are various ways of implementing echo cancellation to address this. One such approach is employed along with the on-the-fly video processing 21. Parallel to the video frame manipulation that is described herein for on-the-fly video processing 21, the audio sample buffers containing the reaction audio stream are also compared to the audio buffers coming from the original content video. In places where the actual sound waves (i.e., signals) match up, the signals are cancelled out of the reaction audio stream recording so that the same audio is not included twice.

In applications where on-the-fly video processing 21 is not utilized, such as a web application, all of the audio packets from the original content video are pre-buffered prior to the recording starting. Echo cancellation system 23 then implements the cancellation as the packets from the reaction recording are received. In particular, the sound waves of the reaction recording are compared to the pre-buffered audio packets, and where the signals match up, the signals are cancelled out of the reaction audio stream recording. In web applications, embedded programs, such as a reaction capture program, generally do not have direct access to the computer's microphone samples; so on-the-fly processing cannot be done.

### Content Processing

Content processing, including sending content messages and receiving reaction content back can either be done in a targeted manner where the recipients are identified before content is sent (e.g., with an email address or user account), or at-scale where users can view content messages in a public forum (e.g., on a website, from a FaceBook posting, etc.) and have their reaction captured without necessarily being identified (e.g., without a user account, email address, etc.).

### Targeted Content Processing

According to an embodiment of the present invention, a targeted content processing system 28 is configured to receive a content message from a content provider, e.g., via a computing system 10 or some other system. The message content generally comprises both the actual content itself (e.g., a video), as well as a list of recipients to receive the content (i.e., targets). The content messages are delivered to recipients who utilize an application (i.e., reaction client system 18) and are identified/registered by a unique identifier by the system (e.g. email address, phone number, username).

Once a content message is received by the targeted reaction system 28, the system 28 processes the content into its applicable parts. The is formatted for delivery to the recipient and the recipients are identified and confirmed prior to transmission of the advertisement to each recipient. In certain embodiments, recipients who have not previously accessed or been identified by the system may be communicated with by an external identifier (e.g., phone number, email address), by which the system 28 can contact the intended recipient and notify the intended recipient that an advertisement is waiting for them.

Once the targeted content processing system 28 has processed the content, the system 28 will then transmit the content to the one or more intended recipients. Upon receipt on the intended recipient's computing system, the computing system of the recipient may notify the intended recipient of receipt of the content by way of a notification (e.g., beep, vibration, force feedback, tone, sound, music, etc.). According to an embodiment of the present invention, the content, as received by each recipient, may be initially obscured from initial review until interaction by the recipient. For instance, the initial advertisement received and viewed by the recipient may be blurred, frosted, pixelated, covered by an advertiser logo or other image, or any combination thereof. One of ordinary skill in the art would appreciate that there are numerous methods for obscuring content, and embodiments of the present invention are contemplated for use with any method for obscuring content.

A content interface system 24 on a recipient's computing system 10 may be configured to detect the availability of an appropriate reaction recording device and/or the availability of the appropriate recipient. This may include both confirming status and ability to use the reaction recording device (e.g., front facing camera on a mobile computing device). Further, this may include confirming the viewer is the intended recipient of the advertisement. This may be accomplished by automated identification of the recipient by the reaction recording device in conjunction with images of the intended recipient stored on the system's components or provided to the system from the advertiser. One of ordinary skill in the art would appreciate that there are numerous methods for automated identification of the recipient, and embodiments of the present invention are contemplated for use with any method for automated identification.

Once the content interface system 24 has confirmed that the recipient is ready to view the content, and, optionally, that the recording device is ready and the appropriate recipient is verified, the content is provided to the recipient concurrent with the recording of the recipient's reaction to the content (i.e., by reaction capture system). In embodiments, the recording of the reaction may include a time period before and after display of the content, to ensure that the entire reaction is recorded (including how the recipient looked prior to receiving the content, to the continued reaction of the recipient after the content has been displayed).

The content interface system 25 may be configured to use one or more markers to determine the beginning and end points of the reaction recording. For instance, the beginning may be any point during display of the content. The end point may be, for instance, a specified amount of time, a duration based on the length of the content (e.g., content video length, estimated reading time for content, content audio length), determined by a demeanor or reaction of the recipient (e.g., returning to normal after the reaction), determined by an interaction with the mobile computing device by the recipient (e.g., pressing of a button or touchscreen), or any combination thereof. One of ordinary skill in the art would appreciate that there are numerous types of end points and begin points that could be utilized with embodiments of the present invention, and embodiments of the present invention are contemplated for use with any begin and end point.

Once the reaction content has been captured, it is sent to the targeted content processing system 28 for processing. Processing of the reaction to the content allows the content provider to piece together the impact and effect the content had on targeted recipients and even allow for filtering and sorting reactions based on any number of characteristics, such as the age of the recipient, gender of the recipient, location of the recipient (e.g., determined by a GPS or other location means integrated into a mobile computing device of the recipient), time spent interacting with the advertisement, intensity of reaction (e.g., volume level, duration of reaction, amount of motion), or any combination thereof. One of ordinary skill in the art would appreciate that there are numerous types of processing that could occur, and embodiments of the present invention are contemplated for use with any type of processing.

### At-Scale Reaction Processing

In an alternative approach, an at-scale reaction processing system 38 may be employed for capturing reactions at scale, i.e., reactions from a set of viewers to a single publically available content item (e.g., on a web application). In these embodiments, a content provider is able to submit a content message to at-scale reaction processing system 38 which causes the content to be selectively published by content publication system 34 to various channels where it can be viewed and reacted to. Any type of channel capable of showing content and receiving a reaction may be utilized, including websites, social media platforms, mobile apps, smart devices, etc.

In this approach, a content provider creates or uploads content (e.g., video, photo, etc.) via computing system 10, e.g., a web or mobile device to at-scale reaction processing system 38. Content can be generated in any manner, including being collected from outside sources such as Vine and YouTube. The at-scale reaction processing system 38 then causes a reaction request containing the content to be published for other users to react to. As noted, the reaction request may be published in any manner, e.g., embedded as a feature within a system web page, within a private label web page, within a social media app, within a mobile app, etc.

In one embodiment, once the content is uploaded to at-scale reaction processing system 38, a unique URL is created for that content item, and the URL can be shared/published anywhere on the Internet via social media, email, SMS, etc. via content publication system.

Anyone who sees this URL can simply click on it on a desktop or mobile device and they will be able to view the content and record their reaction. Users can record their reaction, e.g., using reaction capture system 20, which can for example be loaded onto their computing system 10. Users can also share this URL throughout their own social circle. As reactions from different users are collected, reactions can be aggregated around each piece of content.

The content provider can see all the reactions for each piece of content they uploaded to reactions at scale system, view the videos, share them on the Internet, or download and use them for promotional material. All reaction videos and associated analytics data are provided to the provider via a web or mobile device, e.g., using a dashboard interface 22 that accesses a reaction dashboard system 30 (described in further detail herein). The reaction dashboard system 30 may be utilized to facilitate the set-up and publication of content, track reactions, and display analysis.

It is worth noting that users can thus participate without having a registered account. Thus this feature allows organizations, companies, celebrities, etc., to tap into and leverage the communities of followers they already have without requiring those communities to register for an external product.

### Reaction Analysis

The processing of content may be further implemented by a reaction aggregation and analysis system 32, which allows for analysis of reaction content at varying levels of granularity. For instance, system 32 can be configured to analyze a reaction to an entire video content item and analyze reaction to the content over time. In other embodiments, individual portions of a video content item can be broken down into specific components where reaction analysis is desired. These sub-components can be critical in determining not only the effectiveness of the entire video content item, but each individual portion of the content item. For instance, a video content item could be a movie trailer for a comedy and the sub-components of the video could be comprised of each individual joke/punch-line. In this manner, the system 32 can analyze the effectiveness of each joke. Providers could use this information to alter the content for future audiences in order to select the content sub-components with the greatest reaction and thereby create a more effective content item.

The reaction aggregation and analysis system 32 may automatically classify the type of reactions (either for an entire reaction or for reactions to one or more sub-components of the content item). The system 32 can classify the reactions based on one or more characteristics of the reaction. For instance, the system 32 can be configured to use facial analysis (including gesture recognition) techniques to identify reaction types in a video portion of the response. In other embodiments, the system 32 could be configured to use speech recognition, volume modulation and sound recognition methods in order to identify a reaction type from an audio portion of the response.

For example, the system 32 may select every nth (e.g., 4^{th} or 5^{th}) video frame or timestamp period (e.g., every ½ second) of a reaction content video and apply facial analysis to each frame. Each selected frame will generally include a snippet of a subject (i.e., person) experiencing a reaction to a viewed content item. Facial analysis will examine the subject and determine what emotions the user is experiencing at that moment (e.g., 3 seconds into the video).

In one illustrative embodiment, the facial analysis will evaluate six emotions (anger, disgust, fear, joy, sadness and surprise) and a neutral emotion. At each analyzed frame, each emotion will be given a value such that the sum of the emotions totals 100. Once all of the selected frames are analyzed, a baseline emotion for the subject is calculated. Thus, if a person is always showing a lot of emotion the baseline will be larger and vice versa. The baseline may be determined in any manner, e.g., by averaging the median value in each frame, averaging the highest value in each frame, averaging (1-Median) in each frame, etc. As such, a series of time based analysis results may be produced as follows.

| | Joy | Sad | Anger | Neutral | Surprise | Disgust | Fear |
|---|---|---|---|---|---|---|---|
| Time 1: | 80 | 10 | 2 | 18 | 0 | 0 | 0 |
| Time 2: | 85 | 5% | 1 | 0 | 3 | 3 | 3 |
| Time 3: | 20 | 49 | 6 | 4 | 10 | 11 | 0 |
| Time 4: | 10 | 15 | 2 | 59 | 1 | 2 | 1 |

As can be seen, the subject scores 80 Joy=80, 10% Sad=10, etc., at Time 1; Joy=85, Sad=5, etc., at Time 2, etc. Assuming a baseline emotion of 20, reaction and analysis system 32 determines which emotions scored greater than the baseline of 20, and increments an associated counter, with a total shown at the bottom.

| | Joy | Sad | Anger | Neutral | Surprise | Disgust | Fear |
|---|---|---|---|---|---|---|---|
| Time 1: | 1 | 0 | 0 | 0 | 0 | 0 | 0 |
| Time 2: | 1 | 0 | 0 | 0 | 0 | 0 | 0 |
| Time 3: | 1 | 1 | 0 | 0 | 0 | 0 | 0 |
| Time 4: | 0 | 0 | 0 | 1 | 0 | 0 | 0 |
| Total: | 3 | 1 | 0 | 1 | 0 | 0 | 0 |

In this example, Joy would be considered the dominant emotion, since it had the largest count of 3.

The reaction aggregation and analysis system 32 can also be configured to provide confidence levels for each response or sub-component of a response. In this manner, the system can identify how confident the analysis is that the reaction was correctly analyzed and identified. This will allow the content providers to weigh more heavily its own internal analysis on the confidence level assigned to each response or sub-component of a response. Further, it will allow the provider the ability to review responses or sub-components of responses where the system identified a low confidence level with respect to the analysis of the response/sub-component.

A confidence level may for example be determined based on the scoring values (e.g., in the table above), similarity with neighboring frames, etc. Thus for example, high percentage scores for Joy at Time 1 may suggest a high confidence level. The confidence level may be further bolstered by the fact that Time 2 also had a high score for Joy.

System 32 may combine both audio and video components of the reaction content to identify the reaction type, including through correlating audio and video components together to create a high confidence level that the correct reaction type is recorded. One of ordinary skill in the art would appreciate that there are numerous types of audio and video recognition methods that could be utilized with embodiments of the present invention, and embodiments of the present invention are contemplated for use with any type of audio and video recognition methods.

Reaction aggregation and analysis system 32 may be further configured to identify demographic information about the recipient(s). In some cases, demographic information may be known to the system via information provided to the system either by the content provider, the recipient or some combination thereof. In the case where it is not know, demographic information may also be identified through automated analysis of the response content. For instance, video response content can be analyzed to identify or estimate, via facial recognition methods and other classification methods, certain demographic information. Identification or estimation is possible for such demographic information as age, gender, race and ethnicity. Audio content can similarly be analyzed for demographic information. One of ordinary skill in the art would appreciate that there are numerous types of demographic information that could be identified through video and audio analysis of the reaction content, and embodiments of the present invention are contemplated for use with any such demographic information. Further, like reaction type analysis, the demographic information analysis may be coupled with a confidence level which can be used to identify the confidence the system has in the accuracy of its analysis, which is generally strengthened by the use of multiple content analysis means and through machine learning.

Once classified, the reaction aggregation and analysis system 32 can provide the provider the ability to filter the reactions by reaction type (e.g. laughed, sad, surprised, etc.) as well as by the demographic information of the recipients who reacted. Thus the provider would receive valuable insight into how different demographics respond to a particular content item. For example, an advertiser could see the results for recipients between the ages of 18 and 22 who thought a movie trailer was funny. They could then dig deeper into the information by allowing the system to provide an analysis of the sub-components of the responses. In this manner, the reaction aggregation and analysis system 32 can provide to the content provider exactly what point in the reaction videos the recipients laughed the hardest. As described below, this process could be facilitated by allowing the content provider to open up and view the responses or sub-components of the responses, including through the ability to view more than one reaction at the same time (on the same screen or across multiple displays) and play all of them at the same time so that the response video A, response video B, and response video C would start and end at the exact same time. This would allow content providers to place markers at specific points in the videos. An example of a marker is “hardest laugh received” or “joke didn't land”. Content providers would create a marker once and then bookmark it so it could be applied to other videos with a simple click of a button. The reaction aggregation and analysis system 32 can also be configured to provide content providers reports based on all of this data. Reports could be generated for a specific demographic such as 18-22 year olds and/or for all users who reacted.

The reaction aggregation and analysis system 32 may also provide content providers the ability to create lists of recipients based on previous reactions and then quickly and easily send messages to all of those recipients in the future. For example, if the movie studio mentioned above sent their first message to 100 recipients, they could take all the recipients who reacted with laughter to their first message a new message that includes other scenes from the same movie to see if the recipients find those scenes equally, less, or more funny. Alternatively, the movie studio could send trailers for other similar movies to those recipients. In other embodiments, the advertisers can use the response data from individual recipients to generate advertisement content that specifically appeals to specific recipients based on previous reactions analyzed by the system. The reaction aggregation and analysis system 32 can be configured to analyze content and sort and create a confidence level structure for each content item and each recipient, allowing the content provider to have an estimation of how successful a particular content item came across to all recipients collectively and also with each recipient individually.

According to an embodiment of the present invention, the reaction aggregation and analysis system 32 may be configured to use text-to-speech methods, including natural language processing, in order to analyze and transcribe audio content from response content. The system 32 can then provide content providers with text transcripts of words spoken during reactions. Automatic text/sentiment analysis may also be run on the transcribed text. One of ordinary skill in the art would appreciate that there are numerous methods for analyzing text content for sentiment analysis, and embodiments of the present invention are contemplated for use with any such methods.

The actual reaction content may be sent to the content provider for review. In certain embodiments, the reaction content may be sent directly to the computing device of the provider. In other embodiments, the reaction server system 26 may store the content remotely and provide the provider a link (i.e., Uniform Resource Locator) or other means to access the content. In these embodiments, the provider is able to categorize each reaction received by reaction type. For example, if a movie studio sent a short trailer for a new movie to a 100 people, the movie studio would be able to go through each reaction and tag each one according to reaction type, such as loved it, laughed, disgusted, sad, surprised. This could be in lieu of or in conjunction with the automated reaction analysis as detailed above.

The reaction content may be configured to expire after the occurrence of some event. For instance, the reaction content may be deleted by the system after a specified period of time (e.g., 24 hours). In other examples, the reaction content may be deleted by one or more of, request by the provider, request by the recipient, number of total views or any combination thereof. One of ordinary skill in the art would appreciate that there are numerous events that could be utilized to expire the reaction content, and embodiments of the present invention are contemplated for use with any such event. In certain embodiments, the reaction and content publication system 34 may be configured to allow for the sharing and transmission of the content to third party services, such as social media sites and amongst contacts of the recipient or the advertiser. Even where response content is deleted, the system 34 may be configured to retain analysis data generated from the response content.

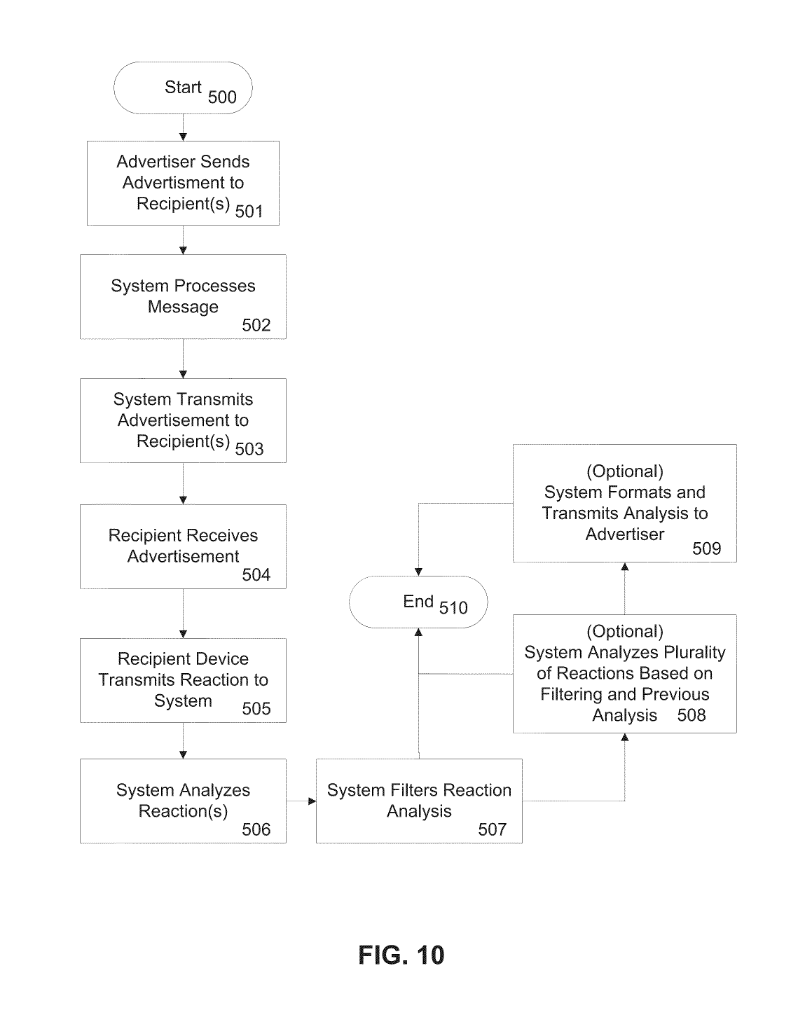

Turning now to FIG. 10, an illustrative method is shown, in accordance with an embodiment of the present invention. The process starts at step 500 with a content provider (e.g., an advertiser) wishing to send a content item (e.g., an advertisement) to one or more recipients in order to get their reaction to the content of the advertisement. At step 501, the advertiser sends the advertisement to the advertisement reaction system 28 for processing. At this point, generally the advertiser has determined the content of the advertisement and the intended recipients and sends this information, generally via a mobile computing device or other computing system 10, to the advertisement reaction system 28 for further processing and transmission of the content.

At step 502, the system 28 processes the advertisement received from the advertiser. The processing of the advertisement generally includes, but is not limited to, the identification of advertisement content and any required processing thereof and the identification of one or more recipients intended to receive the advertisement content. Once advertisement processing is complete, the system 28 transmits the advertisement content to the one or more recipients identified by the advertiser (Step 503).

At step 504, the recipient(s) receive the advertisement content and are notified of the receipt of the advertisement. At this point the advertisement content may be obscured and not visible or viewable by the recipient. Once the recipient engages their mobile computing device or other computing device and confirms that they wish to view the content, the process may proceed. Prior to providing the content, the system 28 may optionally require that the recipient be confirmed (see above regarding recipient identification) and that one or more reaction recording systems be available (e.g., see above regarding availability of forward facing camera or other video/audio capture device).

At this point, the content is displayed to the recipient(s) and the reaction is recorded. Once recorded, the reaction is transmitted to the system 28 (step 505). Once received by the system 28, the reaction aggregation and analysis system 32 will analyze the reaction as described herein. Analysis may include analyzing video and audio response content for characteristics such as reaction type and demographic information, or any combination thereof.

At step 507, the reaction aggregation and analysis system 32 filters the reaction content based on one or more characteristics identified to the system. Characteristics include, but are not limited to, reaction type as a whole, reaction type for any given advertisement sub-component, demographic information, confidence level on any given characteristic, or any combination thereof. Generally filtering is started by the system upon request from an advertiser, but in certain embodiments, the reaction aggregation and analysis system 32 may be configured to generate popular, selected or otherwise advantageous filtered content selections in order to reduce processing and wait time. At this point the process terminates at step 510.

In certain optional embodiments, where there are multiple recipients, the reaction aggregation and analysis system 32 may build an advertisement profile on the reactions received from the recipients in order to provide detailed analysis across numerous responses, including demographic information, reaction types or any combination thereof (step 508). This content can be sent directly to the advertiser as raw data. Otherwise, the reaction aggregation and analysis system 32 can be further configured to format the analysis data for appropriate review and interaction by the advertiser (step 509). In either case, after transmission, the process would terminate at step 510.

### At Scale Processing Environment

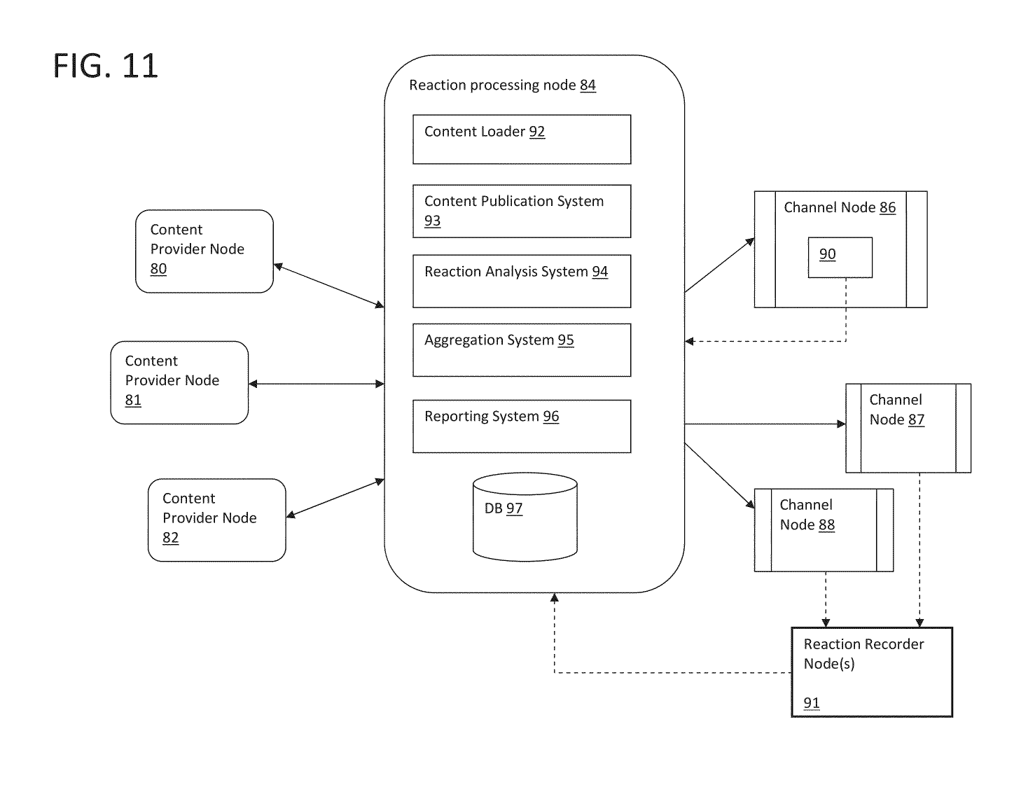

Referring now to FIG. 11, an overview of an at-scale reaction processing environment is shown. The processing platform generally comprises a central reaction processing node 84 that inputs content items (e.g., video, audio, photos, etc.) from content provider nodes 80-82. Once received and processed, the reaction processing node 84 publishes content items (i.e., reaction requests) to channel nodes 86-88. Channel nodes 86-88 may include any platform capable of displaying content messages or linking to other nodes capable of displaying content items (e.g., websites, social media platforms, smart devices, apps, etc.). In some instances, a channel node 86 may include an embedded reaction recorder node 90 for the simultaneous outputting of content and capturing of a reaction (e.g., from a viewer). In other instances, channel nodes 87-88 provide a link to an external reaction recorder node 91 capable of simultaneously outputting content and capturing a reaction. Regardless, once a reaction is captured, it is forwarded back to the reaction management node 84 by the associated reaction recorder node 90, 91.

The reaction processing node 84 generally comprises a content loader 92 for inputting content items from content provider nodes 80-82 in a database 97; a content publication system 93 for publishing content items (or links) to channel nodes 86-88; a reaction analysis system 94 for analyzing reactions to generate reaction analysis data, including, e.g., using facial recognition to determine emotions and demographic data; an aggregation system 95 that collects and manages content items, reactions, and reaction analysis data in database 97; and a reporting system 96 for compiling and formatting analysis data for viewing or other uses, e.g., for use as input into another system.

Depending on the implementation, reaction processing node 84 may automatically pull content items into database 97 from provider nodes 80-81, or content items may be pushed in from content provider nodes 80-81. Accordingly, automated processes such as agents, web crawlers, etc., may be employed to identify content from the Internet and automatically retrieve it for reaction processing. In other cases, content provider nodes 80-82 may comprise portals or client systems that end users can access to upload content items. Once received, content publication system 93 can be implemented to automatically select channels nodes for publishing content, or be directed by inputs from an end user.

### Dashboard

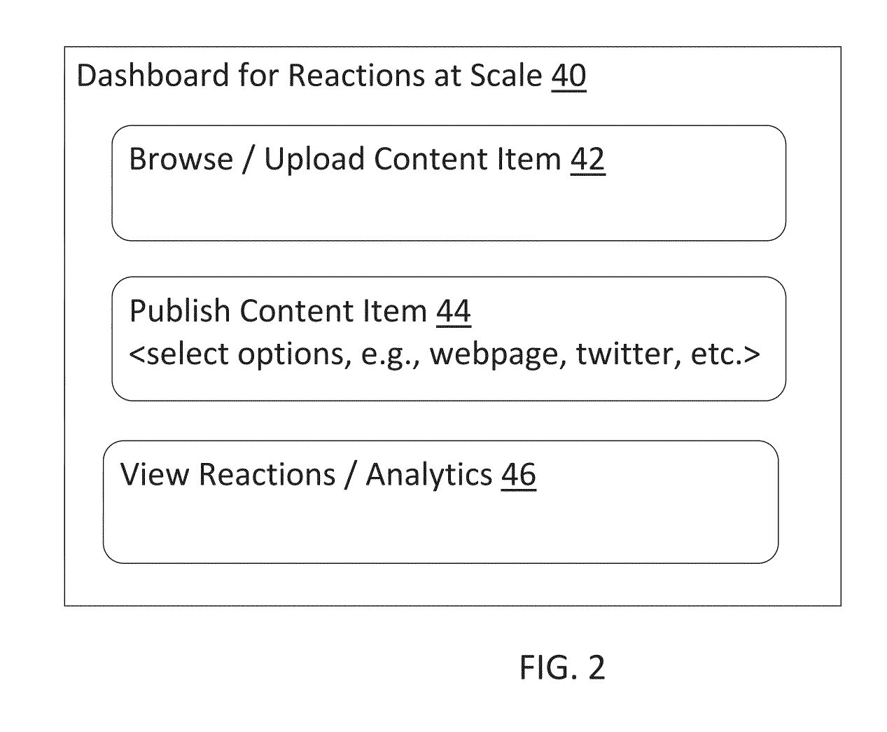

FIG. 2 depicts an illustrative dashboard page 40 that may for example be utilized with at scale reaction processing system 38 (FIG. 1). As shown, the content provider is able to browse/upload a content item 42, selectively publish the content item 44 to various channels (e.g., webpage, twitter, etc.); and view reactions and analytics 46.

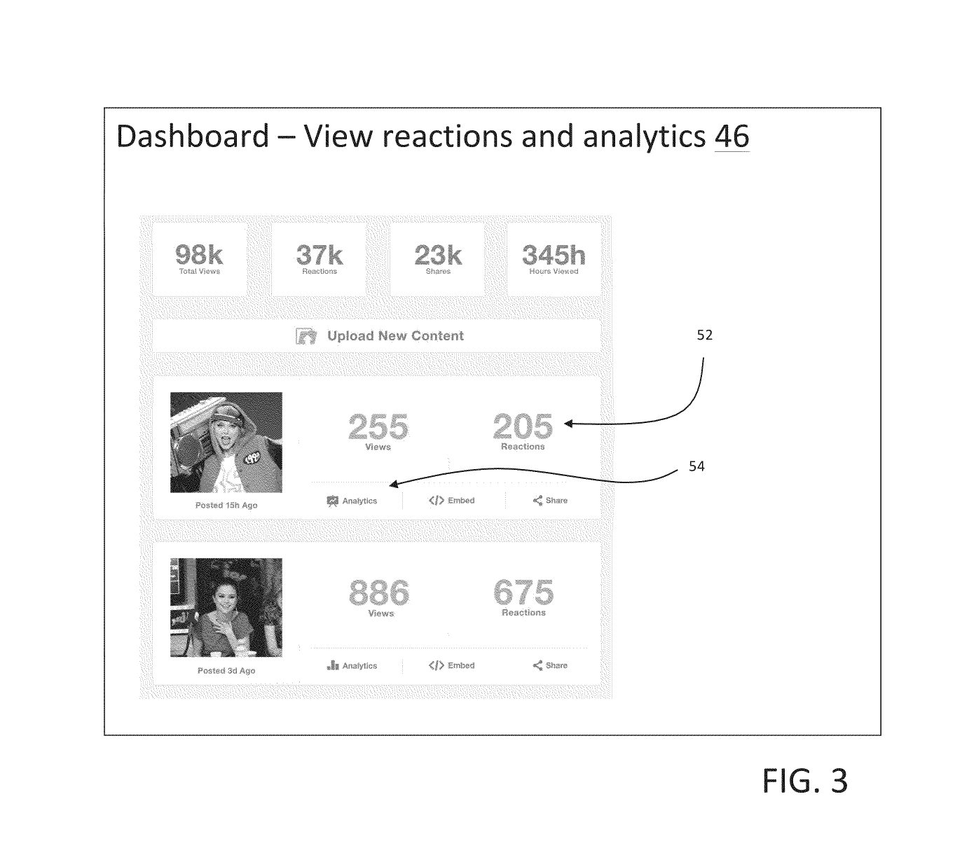

FIG. 3 depicts a view reactions and analytics page 46. In this case, the provider can click on links to view all reactions 52 for a piece of uploaded content and see reaction analytics 54.

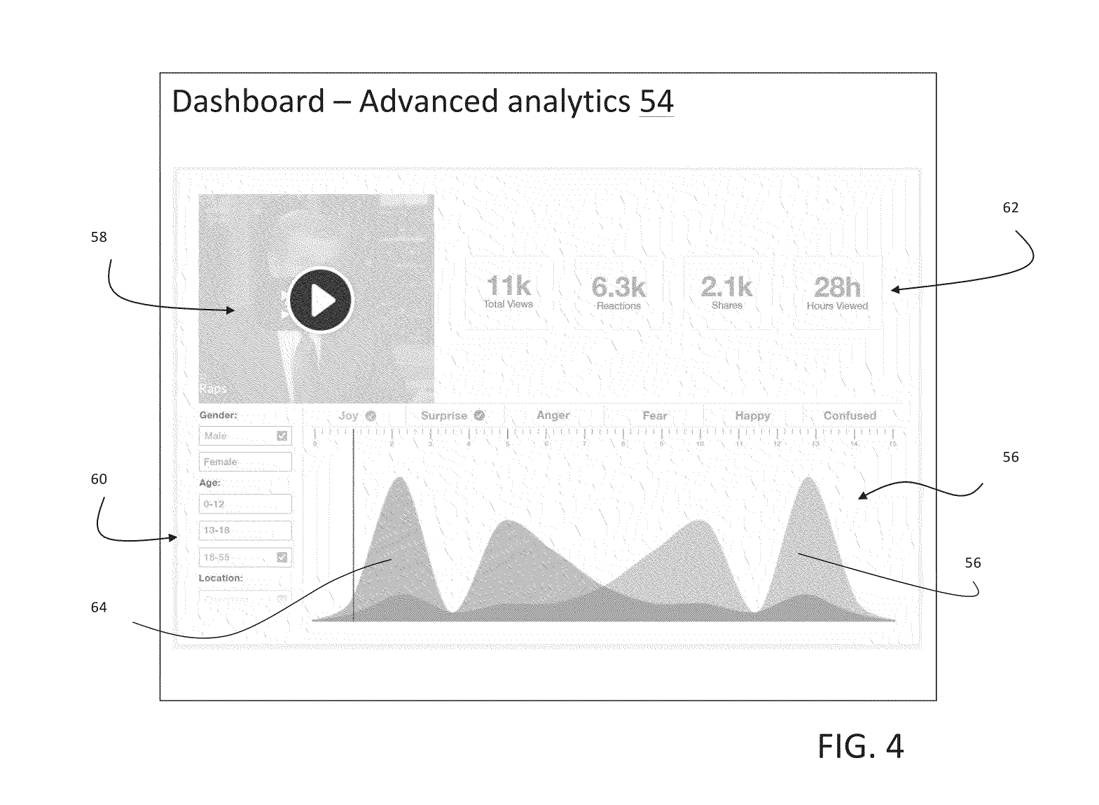

FIG. 4 depicts an advanced analytics page 54 that provide analytics a selected video 58 and demographic selection 60. In this example, viewing details 62 as well as a time based analysis 56 of the video content 58 are shown. As shown, the time based analysis 56 tracks joy and surprise, as determined from analyzed reaction content. Thus, a content provider can use this tool to determine the effectiveness and reaction to a content video over a period of time. For example, the depicted analysis shows that for a male demographic, age 18-55, viewers generally show a large amount of joy at the beginning of the video content 58, and then a high amount of surprise towards the end. Other emotions such as anger, fear, happiness, and confusion may also be graphed and tracked.

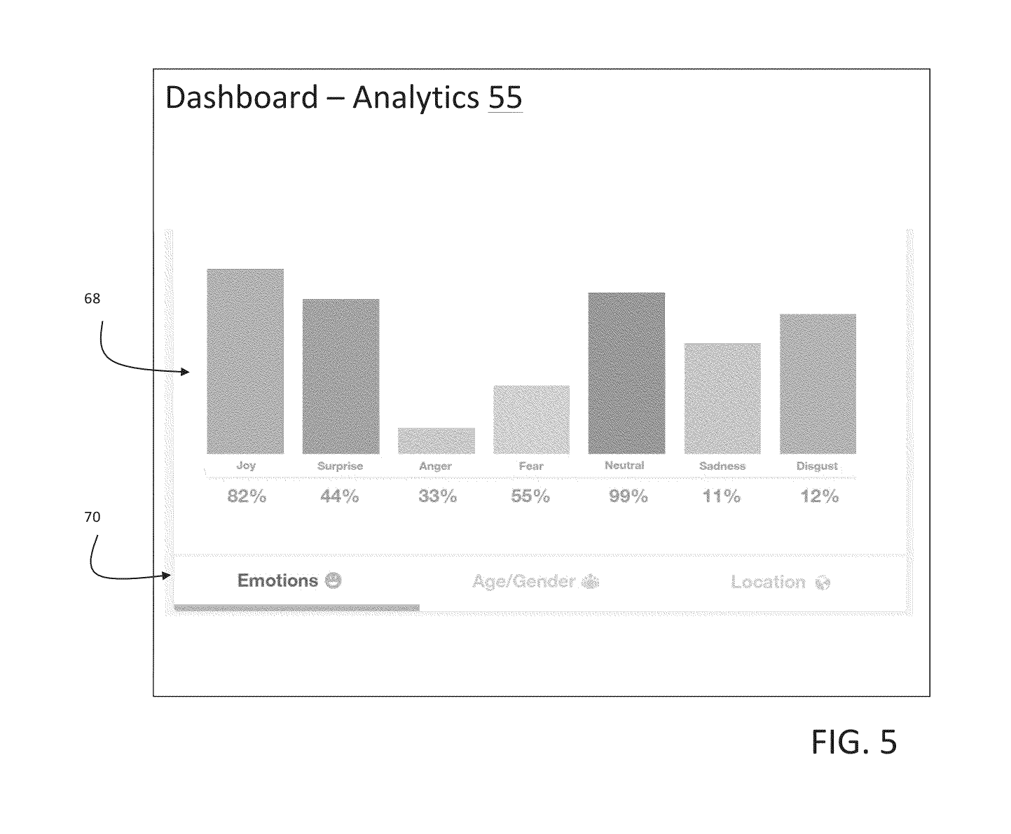

FIG. 5 depicts a further analytics page 55 that shows what percentage of all reactions experienced various emotions (e.g., happy, surprised, sad, etc.). From this page, the user can select 70 not only emotional data categories to view, but also age/gender demographics data, and geospatial location data (e.g., by state, country, etc.).

In one illustrative embodiment, content providers may participate in a paid service that provides access to a dashboard system 30. In such an embodiment, the provider set up how content is to published, viewed and processed. For instance, the service may allow fans to react multiple times to a post, or only allow one reaction per user; upload photo or video content; crop video content on the dashboard to select the section of the video they want to share; choose how to filter reaction videos (when viewing reactions and searching for the best ones); filter by age, gender, location, emotion type, and any combination of those things; choose to embed uploaded content to their website and/or post to social media such as Facebook, Twitter, Google+, email, etc.; select a payment tier; add pre-roll to their content (for example, a radio station or media provider could add a message that appears before a video, e.g., of Taylor Swift, that says: “Hey guys, get ready to react to this never before seen video of Taylor Swift!”; add an advertisement to the pre-roll; selectively place an image/logo and decide where they want it to appear over their content; and customize the border/skin around the video and or use a custom URL that can be easily branded with client or client sponsor images, colors, etc.

### Physical Audience Engagement System

In a further embodiment, a fan engagement system 36 is provided that allows users to engage with celebrities or the like, e.g., with a physical kiosk located at an event, e.g., sports venue, awards show, etc. In one embodiment, the kiosk allows celebrities, e.g., attending an event, to react to video or other content provided by fans. In another embodiment, the kiosk allows fans to react to video content posted by a celebrity.

In the first embodiment, a fan (i.e., user) creates an account (e.g., remotely from the kiosk) which gives the fan access to the fan engagement system 36. The user can then upload content, e.g., a video, and then crop that video to an appropriate length/size. The user can either create a post with that video associated with their account which anyone in the venue can react to or they can post a message directly for someone such as a celebrity at an event. If it is a direct message, the message will be posted for the specific person/company in question to react to.

Users, e.g., celebrities, can approach the booth and react to content without the need for an account. All reaction videos and associated analytics data can be made available via the web or mobile device to the user, the celebrity, the operator of the kiosk, and/or others. For instance, the kiosk operator can see all the celebrity reactions for each piece of content uploaded by fans, view the videos, share them on the Internet, or download and use them for promotional material.

In the second embodiment, the operator uploads content from celebrities, athletes or other influencers. When at the physical booth, a user/fan can view content and have their reaction captured. The kiosk may include a physical construction with a computer system, speakers, microphone, camera, and a touch screen monitor.

### Reaction Interface & Software Development Kit

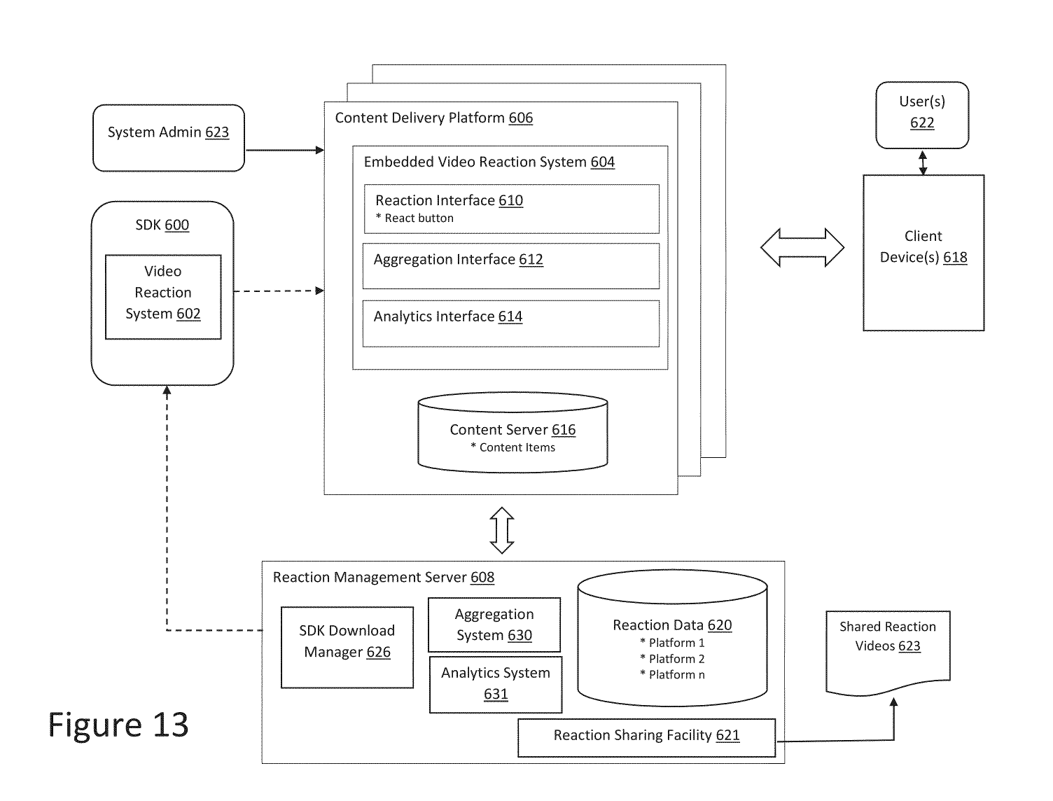

FIG. 13 describes a further embodiment involving a software development kit (SDK) 600 having a video reaction system 602 that is installable in participating content delivery platforms 606 to collect and aggregate video reactions for content items provided by each platform's content server 616. Content delivery platforms 606 may comprise any system that can serve content, and may for example comprise: mobile platforms and Apps, websites, kiosks, social media applications, multimedia applications, RSS feeds, blogs, advertisement feeds, or any other platform capable of serving content items to client device(s) 618 for users 622. Content items may for example comprise pictures, video, audio, digital advertisements, search results, posts, articles, galleries, games, maps, weather, etc.

SDK 600 may for example be downloaded from an SDK download manager 626 from a reaction management server 608, and installed into a platform 606, such as a webpage, an App, etc., by, e.g., a systems administrator 622, programmer, developer, agent, etc. The embedded video reaction system 604 essentially provides plug-in type functionality that allows the content delivery platform 606 to easily collect, manage and analyze video reactions for content items served by the content delivery platform 606.

For example, in a web application, the SDK 600 may be implemented with JavaScript configured to record a reaction video from a client device 618 and upload the reaction video to a remote reaction management server 608 where the reaction video can processed for analytics. The JavaScript may also be used to query reaction data 620.

Once implemented, the embedded video reaction system 604 provides various features including: a reaction interface 610 that allows a user 622 to submit and view video reactions via client device 618; an aggregation interface 612 that aggregates and displays a set of video reactions for unique content items; and an analytics interface 614 that displays analytics associated with collected video reaction data 620.

In this illustrative embodiment, captured reaction data 620 for each platform 606 (e.g., platform 1, platform 2 . . . platform n) is primarily stored and managed remotely at reaction management server 608, which is remote to each content delivery platform 606. Reaction data 620 generally includes reaction videos and associated analytical data, such as time spent viewing content items and reaction videos, number of likes, number of shares, number of reactions, etc. Aggregation system 630 is responsible for organizing or linking reaction videos with associated content items. Thus for example, a given content item posted via content server 616 may have 150 reaction videos posted by users viewing the content item. Aggregation system 630 groups the 150 reaction videos and associates them with the content item. In addition, aggregation system 630 may rank or otherwise order the reaction videos according to a predefined scheme, e.g., more popular reactions may be listed higher up. Analytics system 631 processes the reaction data 620 to evaluate and report on, e.g., emotional data, demographic data, and engagement data.

Accordingly, because the bulk of the processing and storage functions are handled remotely at the reaction management server 608, the embedded video reaction system 604 allows existing content delivery platforms 606 to incorporate the described reaction interface features in a lightweight manner that requires only minimal additional infrastructure. Instead, using, e.g., URL links, etc., that link back to reaction management system 608, users 622 are provided a seamless interface to input and access video reaction data 620 at a content delivery platform 606 for content items being displayed by the content delivery platform 606. This also provide administrators 623 a seamless interface to access analytic information associated with their platform's content items and reaction data 620. Also included in reaction management system 608 is a sharing facility that allows users the ability to share reaction videos from the reaction interface 610. Shared reaction videos may be forwarded to any third party platform using known sharing technology.

For example, on the web, reaction videos may be shared using JavaScript via a platform such as Facebook, Twitter, Google, etc. On mobile devices videos may be shared using a combination of mobile SDKs provided by the platform and native share dialogs such as the iOS Share Sheet.

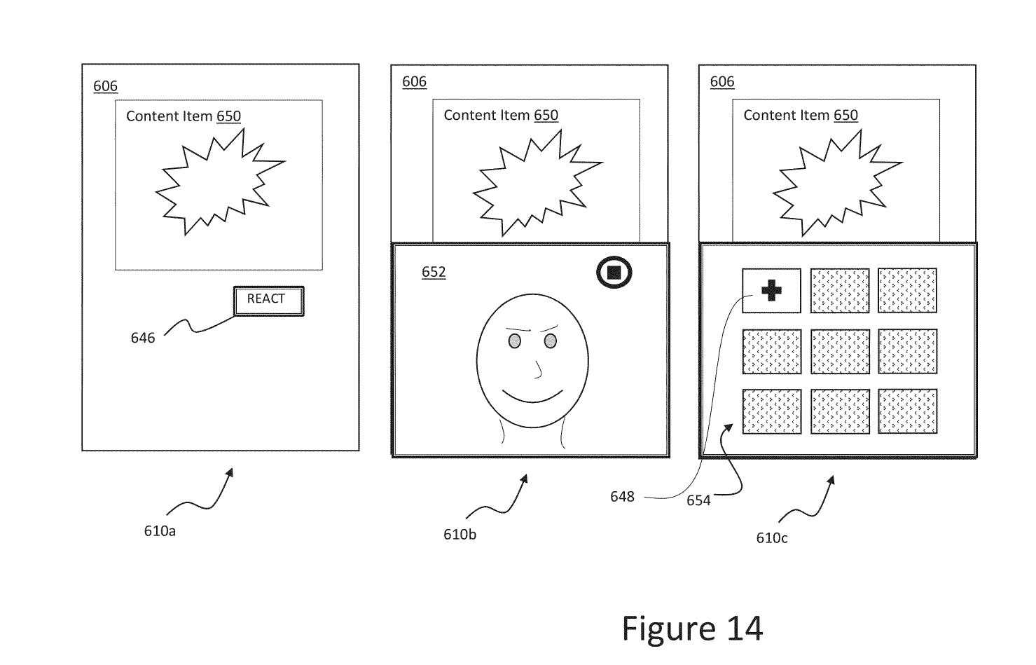

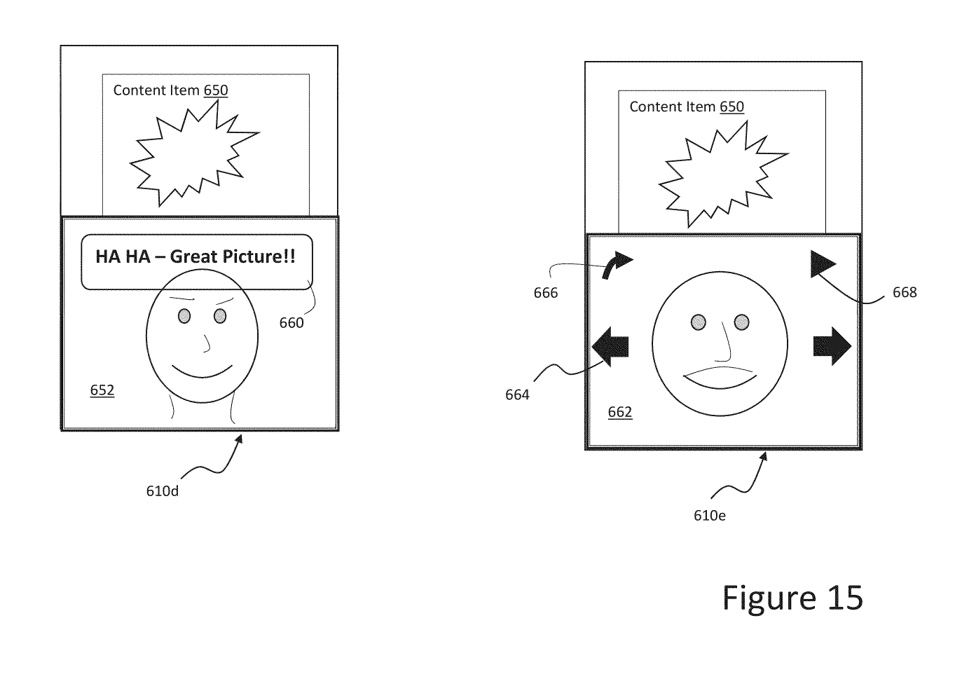

FIGS. 14 and 15 show illustrative features of the reaction interface 610 (shown as 610a, 610b, 610c, 610d, and 610e) implemented in content deliver platform 606. As noted, content delivery platform 606 may comprise any program, webpage, mobile App, etc., that can display content items, e.g., content item 650. In its basic presentation, reaction interface 610a provides a react button 646 that allows a user to record a video reaction. In this illustrative example, pressing of the react button 646 brings the user to interface 610c from which the user can view existing thumbnails 654 and submit a reaction video by pressing the plus icon 648. The specific location and presentation of the react button 646 can vary depending on the particular application, but will typically reside proximate content item 650.

The react button 646 can be added to any application via SDK 600. The button may be initialized with a unique content URL and controls a user interface for recording and aggregating/displaying reactions in a grid for that unique piece of content. In one embodiment, clicking or tapping on the react button 646 will show all of the reactions that have been recorded for a piece of content with the option to share, download, etc. The react button 646 also controls an interface allowing that user to record their own reaction to that content. Once a video reaction is recorded, it is uploaded to the reaction management server 608 to be processed and stored.

Reaction interface 610b shows an example of a video reaction capture window 652 that is displayed when a user presses the plus icon 648 in interface 610c. By interfacing with video reaction capture window 652 the user is able to view, delete, re-record, and post their video reaction using known interface features (e.g., radio buttons, etc.).

Reaction interface 610c shows an example of a thumbnail window 654 of other previously captured video reactions for the content item 650. The previously captured video reactions are aggregated around the content item 650. Thus, each unique content item being displayed by the content delivery platform 606 includes an associated set of aggregated reaction videos. From thumbnail window 654, the user can, e.g., scroll through thumbnails with a swipe action and select a reaction video to view. Thumbnails may be displayed and arranged in any manner by the aggregation system, e.g., based on popularity, time of posting, or any other ranking criteria.

When a user clicks/taps on a react button 646, the SDK 646 (whether it be Javascript, Android Java, or iOS Objective-C/Swift) may for example call a server that responds with a list of all the reactions for an associated piece of content. Contained in that list are the URLs for each reaction video thumbnail. These thumbnails are then displayed in a grid allowing the user to click/tap on them to view the full video.

FIG. 15 shows reaction interface 610d with the recorded video of 610b, but with an added comment 660. The user may for example be given the option to add a comment 660, e.g., using a keyboard or voice recognition, before posting their video.

Reaction interface 610e shows an example of a posted reaction video 662 that is being viewed by the user (e.g., via a selected thumbnail). From interface 610e, the user can scroll through reaction videos by swiping left or right (or optionally with arrows 664), view the video with a default auto-play feature (or with an optional play button 668), and share the reaction video with share button 666. When a user decides to share a reaction video, the user will be given the option to repost it to another platform (using known sharing technology that allows sharing to, e.g., Facebook, Twitter, Email, Text, etc.). When shared, the reaction video is sent either by itself or along with the original content item 650 (or a link to the original content item 650).

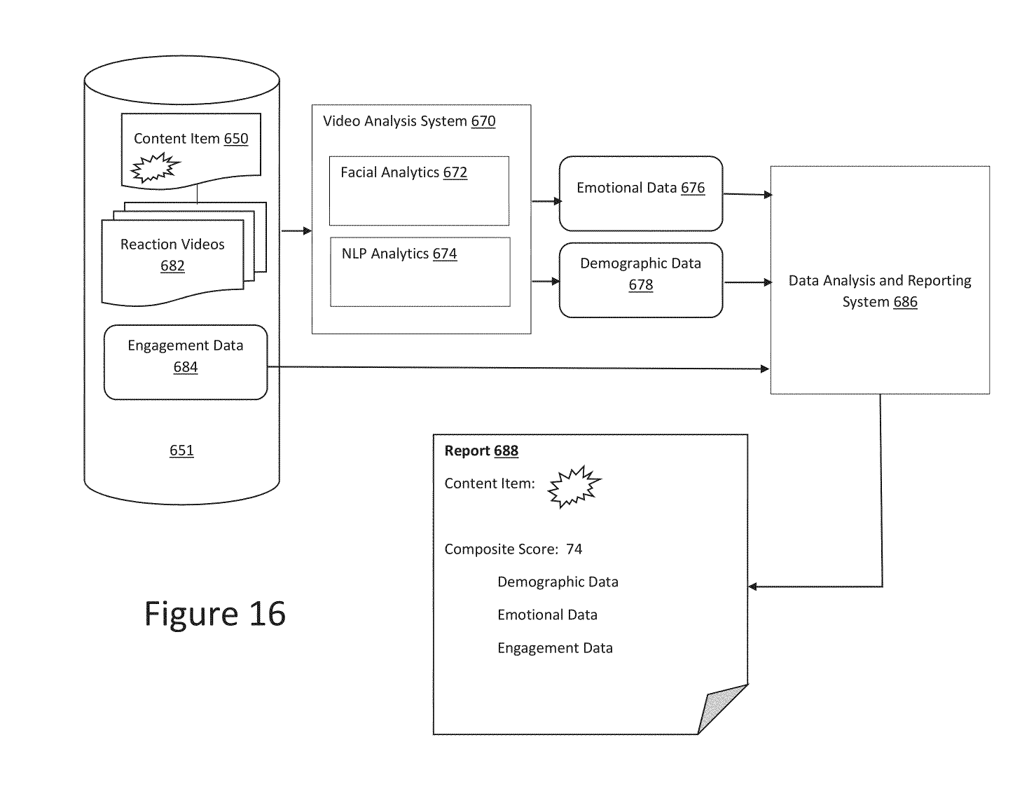

FIG. 16 depicts an overview of an analytics system 631, which generally includes a video analysis system 670, and a data analysis and reporting system 686. An illustrative operation is shown for reaction data 651 of a participating content delivery platform 651. In this example, a set of reaction videos 682 for an associated content item 650 are analyzed by video analysis system 670 to obtain emotional data 676 and/or demographic data 678. Video analysis system 670 may utilize facial analytics of captured images and/or natural language processing (NLP) analytics 674 of captured speech. Facial analytics 672 and/or NLP analytics 674 may for example use an existing software technology applied to one or more frames of a video or recorded speech to detect emotional data 676 such as joy, sadness, etc., based on characteristics of the video images (e.g., smiling, frowning, laughing, quiet, etc.). Facial analytics 672 and/or NLP analytics 674 may also be used to detect demographic data 678 such as age, race, sex, geography, etc.

When a new reaction video is created and uploaded to the server, the server processes the video for various analytical data including but not limited to emotions, demographics (age/gender), location, and performance data such as the device the reaction was recorded on, operating system, time spent viewing videos, number of shares, etc. This data is then saved to a database where it can be queried by multiple servers. One of these servers is the analytics interface 614 (i.e., dashboard) where administrators 623 can manage their account and see the analytics for all the reactions recorded to their content. This dashboard displays charts, raw data, insights, predictions, etc., for the administrator 623 of the content delivery platform 606.

Once calculated, emotional data 676, demographic data 678 and engagement data 684 are fed to and processed by data analysis and reporting system 686. Engagement data 684 for associated reaction videos 686 may for example include number of likes, number of shares, time spent engaged, how often reaction videos were viewed, looped, paused, stopped, etc., number of followers, etc. Data analysis and reporting system 686 can then correlate and process the three streams of data to create reports 688 that can be displayed in the analytics interface 614 (FIG. 13).

In one illustrative embodiment, report 688 may include a composite score for a given content item that weights each of the emotional data 676, demographic data 678 and engagement data 684. For example, the score may be calculated as w1 (emotional score)+w2(demographic score)+w3(engagement score), where w1,w2,w3 are weights.

### Technical Implementation

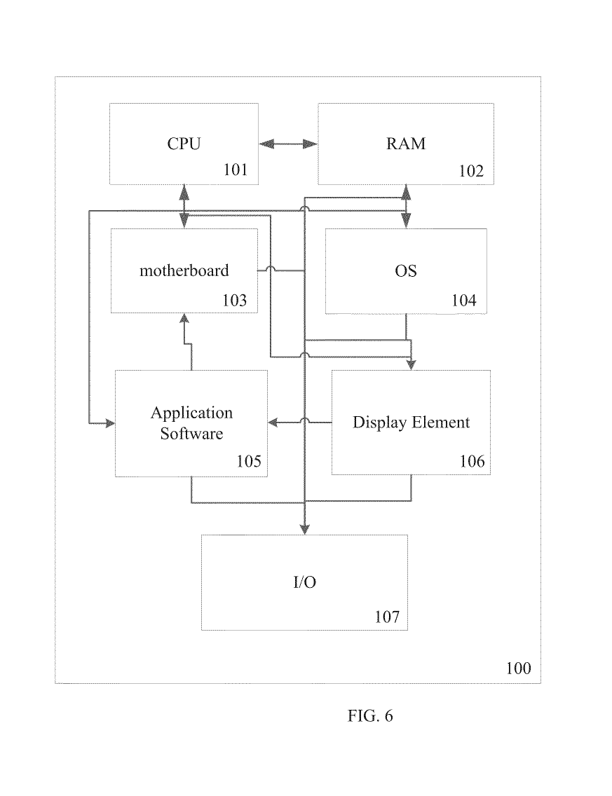

Embodiment of the present invention may be implemented through the use of one or more computing devices. As shown in FIG. 6, one of ordinary skill in the art would appreciate that a computing device 100 appropriate for use with embodiments of the present application may generally be comprised of one or more of a Central processing Unit (CPU) 101, Random Access Memory (RAM) 102, a storage medium (e.g., hard disk drive, solid state drive, flash memory, cloud storage) 103, an operating system (OS) 104, one or more application software 105, one or more programming languages 106 and one or more input/output devices/means 107. Examples of computing devices usable with embodiments of the present invention include, but are not limited to, personal computers, smartphones, laptops, mobile computing devices, tablet PCs and servers. The term computing device may also describe two or more computing devices communicatively linked in a manner as to distribute and share one or more resources, such as clustered computing devices and server banks/farms. One of ordinary skill in the art would understand that any number of computing devices could be used, and embodiments of the present invention are contemplated for use with any computing device.

In an illustrative embodiment, data may be provided to the system, stored by the system and provided by the system to users of the system across local area networks (LANs) (e.g., office networks, home networks) or wide area networks (WANs) (e.g., the Internet). In accordance with the previous embodiment, the system may be comprised of numerous servers communicatively connected across one or more LANs and/or WANs. One of ordinary skill in the art would appreciate that there are numerous manners in which the system could be configured and embodiments of the present invention are contemplated for use with any configuration.

In general, the approaches provided herein may be consumed by a user of a computing device whether connected to a network or not. According to an embodiment of the present invention, some of the applications of the present invention may not be accessible when not connected to a network, however a user may be able to compose data offline that will be consumed by the system when the user is later connected to a network.

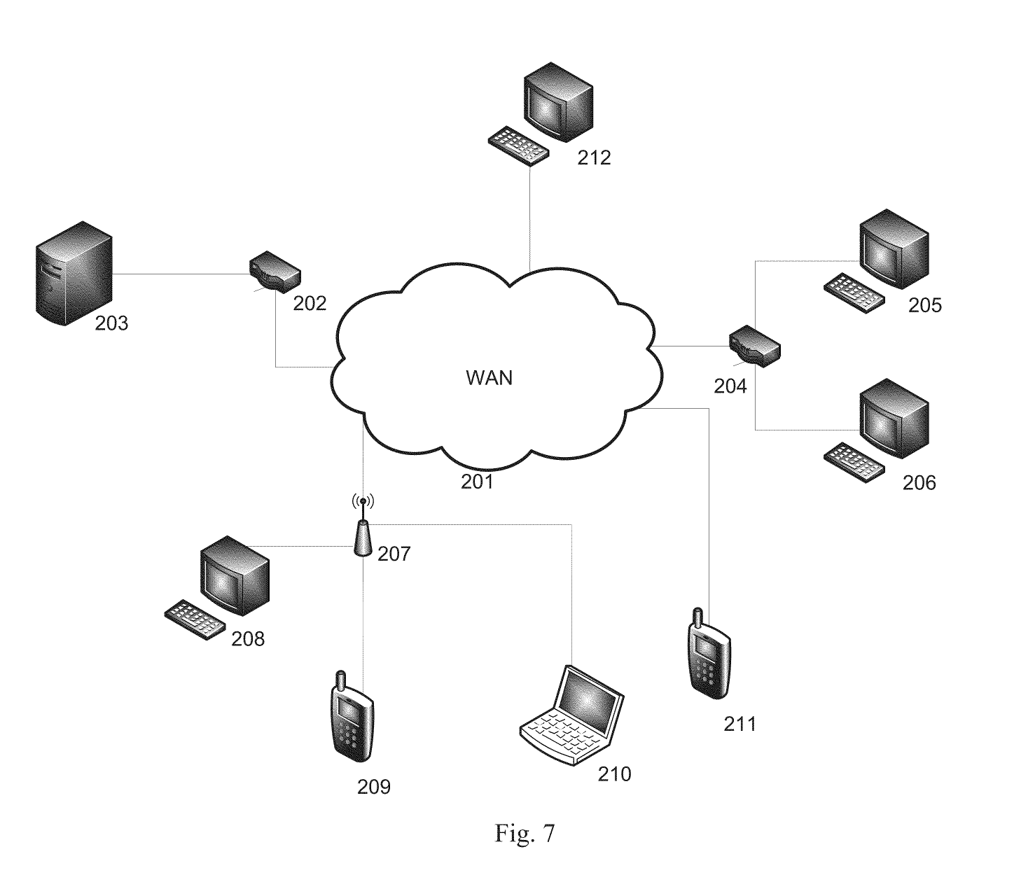

Referring to FIG. 7, a schematic overview of a system in accordance with an embodiment of the present invention is shown. The system is comprised of one or more application servers 203 for electronically storing information used by the system. Applications in the application server 203 may retrieve and manipulate information in storage devices and exchange information through a Network 201 (e.g., the Internet, a LAN, WiFi, Bluetooth, etc.). Applications in server 203 may also be used to manipulate information stored remotely and process and analyze data stored remotely across a Network 201 (e.g., the Internet, a LAN, WiFi, Bluetooth, etc.).

According to an illustrative embodiment, as shown in FIG. 7, exchange of information through the Network 201 may occur through one or more high speed connections. In some cases, high speed connections may be over-the-air (OTA), passed through networked systems, directly connected to one or more Networks 201 or directed through one or more routers 202. Router(s) 202 are completely optional and other embodiments in accordance with the present invention may or may not utilize one or more routers 202. One of ordinary skill in the art would appreciate that there are numerous ways server 203 may connect to Network 201 for the exchange of information, and embodiments of the present invention are contemplated for use with any method for connecting to networks for the purpose of exchanging information. Further, while this application refers to high speed connections, embodiments of the present invention may be utilized with connections of any speed.

Components of the system may connect to server 203 via Network 201 or other network in numerous ways. For instance, a component may connect to the system i) through a computing device 212 directly connected to the Network 201, ii) through a computing device 205, 206 connected to the WAN 201 through a routing device 204, iii) through a computing device 208, 209, 210 connected to a wireless access point 207 or iv) through a computing device 211 via a wireless connection (e.g., CDMA, GMS, 3G, 4G) to the Network 201. One of ordinary skill in the art would appreciate that there are numerous ways that a component may connect to server 203 via Network 201, and embodiments of the present invention are contemplated for use with any method for connecting to server 203 via Network 201. Furthermore, server 203 could be comprised of a personal computing device, such as a smartphone, acting as a host for other computing devices to connect to.

The present invention generally relates to the ability to capture reactions to specific moments in time. In particular, embodiments of the present invention are configured to provide users the ability to send messages to one or more recipients and have the reaction of those recipients be recorded concurrently with the recipient's viewing of the message content. Message content could include, but is not limited to, video content, audio content, text content, graphic content, photo content or any combination thereof. One of ordinary skill in the art would appreciate that there are numerous types of message content that could be utilized with embodiments of the present invention, and embodiments of the present invention are contemplated for use with any type of message content.

In an embodiment of the present invention, the system is comprised of one or more servers configured to manage the transmission and receipt of content and data between users and recipients. The users and recipients may be able to communicate with the components of the system via one or more mobile computing devices or other computing device connected to the system via a communication method supplied by a communication means (e.g., Bluetooth, WIFI, CDMA, GSM, LTE, HSPA+). The computing devices of the users and recipients may be further comprised of an application or other software code configured to direct the computing device to take actions that assist in the generation and transmission of messages as well as the recording and transmission of reactions. Components of the system act as an intermediary between the computing devices of the users and the recipients.

The foregoing description of various aspects of the invention has been presented for purposes of illustration and description. It is not intended to be exhaustive or to limit the invention to the precise form disclosed, and obviously, many modifications and variations are possible. Such modifications and variations that may be apparent to an individual in the art are included within the scope of the invention as defined by the accompanying claims.

What is claimed is:

1. A software developer kit (SDK) comprising programming code that is installable on a content delivery platform, and when installed and executed, comprises:
a reaction interface that is displayed with the content delivery platform and captures and uploads video reactions from client devices in response to content items served by the content delivery platform, wherein each video reaction is externally stored in a remote server and is viewable in the reaction interface, and wherein the reaction interface includes a sharing facility that allows video reactions to be shared over a network;
an aggregation interface that visually aggregates, in the reaction interface, sets of video reactions with associated content items served by the content delivery platform; and
an analytics interface that displays reaction analytics for content items, wherein the reaction analytics include emotional analytics, demographic analytics, and engagement analytics.

2. The SDK of claim 1, wherein the reaction interface includes a react button that can be activated by a user operating a client device to capture a video reaction for a displayed content item.

3. The SDK of claim 2, wherein the reaction interface includes a viewing window for replaying a captured video reaction.

4. The SDK of claim 3, wherein the reaction interface includes an editor for adding a caption to a captured video reaction.

5. The SDK of claim 1, wherein the reaction interface includes a thumbnail display for displaying an aggregated set of video reaction thumbnails captured for a displayed content item.

6. The SDK of claim 1, wherein the aggregated set of video reaction thumbnails are scrollable and positionable according to a calculated rank.

7. The SDK of claim 1, wherein the reaction analytics are based on at least one of facial analysis and natural language processing.

8. A content delivery platform, comprising:
a reaction interface that captures and uploads video reactions from client devices in response to content items served by the content delivery platform, wherein uploaded video reactions are externally stored in a remote server and are viewable in the reaction interface, and wherein the reaction interface includes a sharing facility that allows video reactions to be shared over a network;
an aggregation interface that visually aggregates, in the reaction interface, sets of video reactions with associated content items served by the content delivery platform; and
an analytics interface that displays reaction analytics for content items, wherein the reaction analytics include emotional analytics, demographic analytics, and engagement analytics.

9. The content delivery platform of claim 8, wherein the reaction interface includes a react button that can be pressed by a user operating a client device to capture a video reaction for a displayed content item.

10. The content delivery platform of claim 9, wherein the reaction interface includes a viewing window for replaying a captured video reaction.

11. The content delivery platform of claim 10, wherein the reaction interface includes an editor for adding a caption to a captured video reaction.

12. The content delivery platform of claim 11, wherein the reaction interface includes a thumbnail display for displaying an aggregated set of video reaction thumbnails captured for a displayed content item.

13. The content delivery platform of claim 8, wherein the aggregated set of video reaction thumbnails are scrollable and positionable according to a calculated rank.

14. The content delivery platform of claim 8, wherein the reaction analytics are based on at least one of facial analysis and natural language processing.

15. A computer program product stored a computer readable storage medium, which when executed by a computing system having a content delivery platform, comprises:
program code that captures and uploads video reactions from client devices in response to content items served by the content delivery platform, wherein uploaded video reactions are externally stored in a remote server;
program code that visually aggregates sets of video reactions with associated content items served by the content delivery platform;
program code for displaying video reactions;
program code that shares video reactions over a network; and
program code that displays reaction analytics for content items, wherein the reaction analytics include emotional analytics, demographic analytics, and engagement analytics.

16. The computer program product of claim 15, wherein the program code that captures and uploads video reactions renders a react button that can be pressed by a user operating a client device to capture a video reaction for a displayed content item.

17. The computer program product of claim 16, wherein program code for displaying video reactions renders a viewing window for replaying a captured video reaction.

18. The computer program product of claim 15, wherein the program code that captures and uploads video reactions includes an editor for adding a caption to a captured video reaction.

19. The computer program product of claim 15, wherein the program code that visually aggregates sets of video reactions includes a thumbnail display for displaying an aggregated set of video reaction thumbnails captured for a displayed content item.

20. The computer program product of claim 15, wherein the aggregated set of video reaction thumbnails are scrollable and positionable according to a calculated rank.
